(19) United States
(12) Patent Application Publication
(10) Pub. No.: US 2026/0149918 A1
(43) Pub. Date: May 28, 2026

(54) SPEAKER ASSEMBLY, SEAT, AND ELECTRONIC DEVICE

(71) Applicant: AAC Acoustic Technologies (Shanghai) Co., Ltd., Shanghai (CN)

(72) Inventors: Denglin Li, Shanghai (CN); Yuheng Jiang, Shanghai (CN); Nan Cao, Shanghai (CN); Hongxing Wang, Shanghai (CN); Yulei Zhang, Shanghai (CN)

(21) Appl. No.: 19/177,676

(22) Filed: Apr. 14, 2025

Related U.S. Application Data
(63) Continuation of application No. PCT/CN2024/132643, filed on Nov. 18, 2024.

(51) Int. Cl. H04R 1/40; H04R 1/02; H04R 3/12; H04R 5/02

(52) U.S. Cl. CPC H04R 1/403; H04R 1/025; H04R 3/12; H04R 5/023; H04R 2499/13

(57) ABSTRACT

The disclosure relates to the technical field of sound-electricity conversion, and discloses a speaker assembly, a seat, and an electronic device, which can realize directional sound emission of audio and has a simple structure. The speaker assembly includes a mounting body, a plurality of dipole speaker units, and a control unit. The plurality of dipole speaker units are disposed inside the mounting body and are configured to form a dipole sound source to achieve directional sound emission. The control unit is electrically connected with each dipole speaker unit of the plurality of dipole speaker units and configured to control at least one control parameter for the dipole speaker unit of the plurality of dipole speaker units to adjust a sound field of the dipole speaker unit in a preset region.

### CROSS REFERENCE TO RELATED APPLICATIONS

The present application is a continuation of PCT Patent Application No. PCT/CN2024/132643, filed Nov. 18, 2024, each of which is incorporated by reference herein in its entirety.

### TECHNICAL FIELD

The various embodiments described in this document relate in general to the technical field of acoustic-electrical conversion, and more specifically to a speaker assembly, a seat, and an electronic device.

### BACKGROUND

With the continuous improvement of technologies, advanced sound field control technologies, such as directional sound emission technology and independent sound-zone technology, have been continuously developed in vehicles and other fields. The directional sound emission technology is used to achieve playback of audio contents in designated regions in the vehicle and private calls in the vehicle, thereby ensuring the privacy of the call content. The independent sound-zone technology is used to realize regional playback of audio in the vehicle, so as to meet the needs of passengers in different locations to enjoy different audio contents concurrently, or ensure passengers in different locations do not disturb each other when some passengers enjoy audio and others need to rest or talk.

### SUMMARY

The present disclosure aims to provide a speaker assembly, a seat, and an electronic device, which may achieve directional sound emission of audio and may be simple in structure.

To achieve the above-mentioned objectives, technical solutions of the present disclosure provide a speaker assembly, including: a mounting body; a plurality of dipole speaker units, where the plurality of dipole speaker units are disposed inside the mounting body and configured to form a dipole sound source to achieve directional sound emission; and a control unit electrically connected with each dipole speaker unit of the plurality of dipole speaker units and configured to control at least one control parameter for the dipole speaker unit to adjust a sound field of the dipole speaker unit in a preset region.

In some embodiments, the dipole speaker unit includes two first speakers disposed separately, and driving signals for the two first speakers have opposite phases and a same amplitude. Each of the two first speakers includes a first housing and a first sounding part, where the first housing has a first receiving cavity, the first sounding part is provided inside the first housing and divides the first receiving cavity into a first front sound cavity and a first rear sound cavity, where the first housing defines at least one first sound-emitting hole, and the first front sound cavity communicates with outside of the first housing through the at least one first sound-emitting hole, where the first rear sound cavity is enclosed, and first rear sound cavities of the two first speakers face each other.

In some embodiments, the dipole speaker unit includes two second speakers that are communicatively coupled to each other, and driving signals for the two second speakers have opposite phases and a same amplitude. The two second speakers communicatively coupled to each other include a second housing and two second sounding parts, and the second housing defines a second receiving cavity, where the two second sounding parts are disposed opposite to each other in the second housing, and divides the second receiving cavity into a second rear sound cavity and two second front sound cavities, where the second housing defines a plurality of second sound-emitting holes, each of the two second front sound cavities is communicated with outside of the second housing through a corresponding second sound-emitting hole of the plurality of second sound-emitting holes, and the second rear sound cavity is enclosed.

In some embodiments, the dipole speaker unit includes a third speaker. The third speaker includes a third housing and a third sounding part, where the third housing defines a third receiving cavity, and the third sounding part is provided in the third housing and divides the third receiving cavity into a third front sound cavity and a third rear sound cavity, where the third housing has at least one third sound-emitting hole and at least one fourth sound-emitting hole, the third front sound cavity communicates with outside of the third housing through the at least one third sound-emitting hole, and the third rear sound cavity communicates with the outside of the third housing through the at least one fourth sound-emitting hole.

In some embodiments, each of the plurality of dipole speaker units includes any one of the dipole speaker unit including two first speakers separately disposed, the dipole speaker unit including two second speakers coupled to each other, and the dipole speaker unit including one third speaker; or some of the plurality of dipole speaker units each include the two first speakers separately disposed or the two second speakers coupled to each other, and remaining dipole speaker units of the plurality dipole speaker units each include one third speaker.

In some embodiments, the mounting body is a headrest or a neck pillow.

In some embodiments, the headrest or the neck pillow includes a straight strip-shaped body portion, the straight strip-shaped body portion has two opposite ends, and a respective dipole speaker unit of the plurality of dipole speaker units is disposed inside a corresponding end of the two opposite ends of the straight strip-shaped body portion; or the headrest or the neck pillow includes a curved body portion, and the curved body portion includes a straight strip-shaped subpart and two curved subparts, where each of the two curved subparts is located at a corresponding end of both ends of the straight strip-shaped subpart, and a respective dipole speaker unit of the plurality of dipole speaker units is provided inside a corresponding curved subpart of the two curved subparts.

In some embodiments, the at least one control parameter includes at least one of an amplitude of a driving signal, a phase of the driving signal, a delay time of the driving signal, and a frequency of the driving signal.

In some embodiments, a seat is provided. The seat includes the speaker assembly described above. The mounting body of the speaker assembly is a headrest or a neck pillow of the seat.

In some embodiments, ana electronic device is provided. The electronic device includes the seat described above.

The technical solutions of the present disclosure provide the speaker assembly, the seat, and the electronic device. The speaker assembly forms the dipole sound source through the dipole speaker units, thereby achieving directional sound emission. In addition, with aid of the control unit, control parameters for each of the dipole speaker units are adjusted, thereby further adjusting the sound field of each dipole speaker unit in the preset region, thus further enhancing the effect of directional sound emission and significantly improving the user experience.

### BRIEF DESCRIPTION OF THE DRAWINGS

In order to more clearly explain the technical solutions in the embodiments of the present disclosure, the accompanying drawings that need to be used in the description of the embodiments will be briefly introduced below. It is obvious that the accompanying drawings described in the following are only some embodiments of the present disclosure, and for those skilled in the art, other accompanying drawings can be obtained from these accompanying drawings without making creative efforts.

FIG. 1 is a schematic structural diagram of a speaker assembly according to an embodiment of the present disclosure.

FIG. 2 is a curve graph of directivity of a dipole sound field according to an embodiment of the present disclosure.

FIG. 3 is a schematic structural diagram of a dipole speaker unit according to an embodiment of the present disclosure.

FIG. 4 is a schematic structural diagram of a dipole speaker unit according to another embodiment of the present disclosure.

FIG. 5 is a schematic structural diagram of a dipole speaker unit according to yet another embodiment of the present disclosure.

FIG. 6 is a schematic structural diagram of a seat according to an embodiment of the present disclosure.

FIG. 7A is a top view of FIG. 6.

FIG. 7B is a top view of the user's head.

FIG. 8 is a schematic structural diagram of a seat according to another embodiment of the present disclosure.

FIG. 9A is a top view of FIG. 8.

FIG. 9B is a top view of the user's head.

FIG. 10 is a schematic structural diagram of a seat according to yet another embodiment of the present disclosure.

FIG. 11A is a top view of FIG. 10.

FIG. 11B is a top view of the user's head.

FIG. 12 is a schematic structural diagram of a seat according to yet another embodiment of the present disclosure.

FIG. 13A is a top view of FIG. 12.

FIG. 13B is a top view of the user's head.

FIG. 14 is a schematic structural diagram of a seat according to another embodiment of the present disclosure.

FIG. 15A is a top view of FIG. 14.

FIG. 15B is a top view of the user's head.

FIG. 16 is a schematic structural diagram of a seat according to another embodiment of the present disclosure.

FIG. 17A is a top view of FIG. 16.

FIG. 17B is a top view of the user's head.

FIG. 18 is a schematic structural diagram of a vehicle according to an embodiment of the present disclosure.

FIG. 19 is a schematic flow chart of a method for control of an electronic device according to an embodiment of the present disclosure.

FIG. 20A is a top view of a straight strip-shaped body portion.

FIG. 20B is a top view of a curved body portion.

FIG. 20C is a top view of a user's head.

FIG. 21 is a schematic structural view of a seat according to an embodiment of the present disclosure.

FIG. 22A is a top view of a neck pillow of FIG. 21.

FIG. 22B is another top view of the neck pillow of FIG. 21.

FIG. 22C is a top view of a user's head.

### DETAILED DESCRIPTION OF THE EMBODIMENTS

In order to make the object, technical solution, and advantages of the present disclosure clearer, embodiments of the present disclosure will be described in detail below with reference to the accompanying drawings. However, one of ordinary skill in the art will appreciate that many technical details have been set forth in various embodiments of the present disclosure in order to better understand the present disclosure by the reader. However, even without these technical details and various changes and modifications based on the following embodiments, the claimed technical solutions of the present disclosure can be realized.

In the description of the embodiments of the present disclosure, the technical terms “first”, “second” and the like are used only to distinguish different objects, and are not intended to indicate or imply relative importance or implicit indication of the number, specific order, or primary-secondary relationship of the indicated technical features. In the embodiments of the present disclosure, “a plurality” means two or more unless explicitly and specifically defined otherwise.

Reference herein to an “embodiment” means that a particular feature, structure, or characteristic described in connection with the embodiment may be included in at least one embodiment of the present disclosure. The appearance of the phrase in various places in the specification does not necessarily refer to the same embodiment, nor is it an independent or alternative embodiment that is mutually exclusive from other embodiments. It is explicitly and implicitly understood by those skilled in the art that the embodiments described herein may be combined with other embodiments.

In the description of embodiments of the present disclosure, orientation or positional relationship indicated by technical terms such as “center”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumferential”, etc. are based on the orientation or positional relationship shown in the accompanying drawings. This is merely for the convenience of describing the embodiments of the present disclosure and simplifying the description, rather than indicating or implying that the device or element referred to must have a specific orientation, be constructed and operated in a specific orientation. Therefore, it should not be construed as a limitation to the embodiments of the present disclosure.

In the description of embodiments of the present disclosure, unless otherwise explicitly specified and limited, technical terms such as “mounted”, “connecting/coupling”, “connected/coupled” and “fixed” should be understood in a broad sense, for example, they may be a fixed connection, a detachable connection, or an integrated formed. They may also be achieved by a mechanical connection or an electrical connection. They can be directly connected, or indirectly connected through an intermediate medium, or they can be the internal communication of two elements or the interaction between two elements. For those skilled in the art, the specific meanings of the above terms in the embodiments of the present disclosure can be understood according to specific circumstances.

In the drawings corresponding to embodiments of the present disclosure, a thickness and an area of each of layers are enlarged for better understanding and ease of description.

In the description of embodiments of the present disclosure, when a certain component “includes” another component, other components are not excluded unless otherwise specified, and other components may be further included.

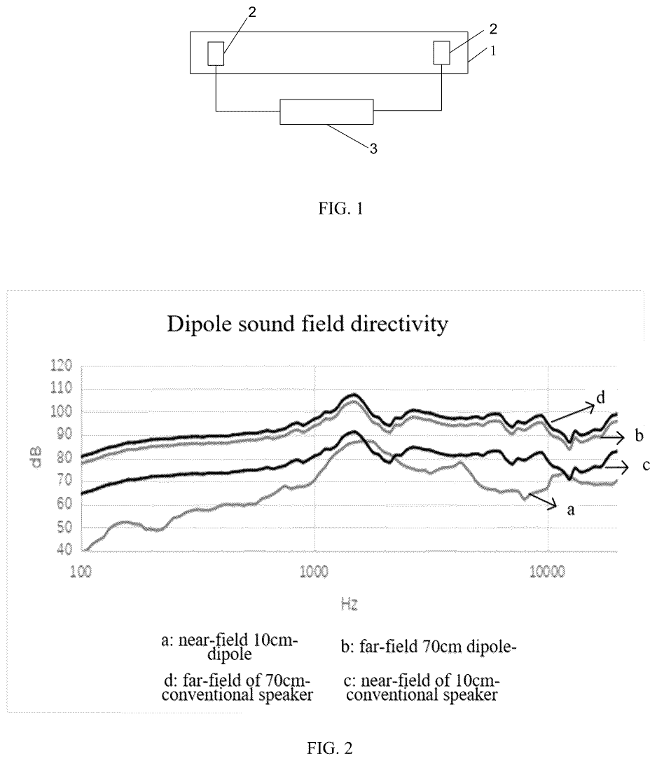

Referring to FIG. 1, embodiments of the present disclosure provide a speaker assembly. The speaker assembly includes a mounting body 1, a plurality of dipole speaker units 2, and a control unit 3. The plurality of dipole speaker units 2 are disposed inside the mounting body. The plurality of dipole speaker units 2 are configured to form a dipole sound source to achieve directional sound emission. The control unit 3 is electrically connected to each dipole speaker unit 2 of the plurality of dipole speaker units 2 and configured to control at least one control parameter for the dipole speaker unit 2 to adjust a sound field of the dipole speaker unit 2 in a preset region.

There is no restriction on a specific structure of the mounting body and the mounting body can be provided according to different application scenarios. For example, if the speaker assembly is applied to a vehicle, the mounting body may be a headrest, a neck pillow, or a portion of a vehicle seat.

The above-mentioned dipole sound source refers to a synthetic/combined sound source formed by two-point sound sources very close to each other, where the two-point sound sources have a same vibration amplitude and inverted phases. There is no restriction on the specific configuration of the dipole speaker units as long as a dipole sound source can be generated.

It is to be noted that two driving voltages with a same amplitude and completely inverted phases can be used to drive the dipole speaker units concurrently to achieve cancellation of far-field radiated audio in the mid-and-low frequency bands, thereby improving the audio directivity effect in the mid-and-low frequency bands to realize directional sound emission. The sound field directivity of the dipole speaker units and a conventional speaker (only one sound source point is generated) in both near-field of 10 cm and a far-field distance of 70 cm are detected respectively, where detection results obtained are shown in FIG. 2. Referring to FIG. 2, curves a and b respectively show signal intensities at near-field of 10 cm and far-field of 70 cm when the dipole speaker units are used, and curves c and d respectively show signal intensity at near-field of 10 cm and far-field of 70 cm when the conventional speaker is used. By comparison, it shall be concluded that the sound field directivity of the dipole speaker units is significantly improved in the low frequency range of 100 Hz- 1000 Hz.

There is no restriction on the structure and type of the above control unit. For example, the control unit may include a control chip, and the control ship may be a microcontroller unit (MCU) chip, a field programmable gate array (FPGA) chip, a digital signal processor (DSP) chip, or an advanced RISC machines (ARM) chip, and other types of chips.

There is no restriction on the above-described control parameter of the respective dipole speaker unit. For example, the control parameter may be an amplitude of the driving signal, a phase of the driving signal, a delay time of the driving signal, or a frequency of the driving signal. The control unit can adjust the intensity or the like of the sound signal emitted by the respective dipole speaker unit by controlling the amplitude or the like of the driving signal, thereby adjusting the sound field of the respective dipole speaker unit in the preset region. The at least one control parameter can be obtained by performing a time domain or frequency domain system identification method on the electrical/sound field performance of the respective dipole speaker unit, or can be obtained by calculating according to physical parameters of the respective dipole speaker unit, which specifically can be obtained through relevant technologies, and will not be elaborated here. There is no restriction on characteristics of the control parameters and the control parameters may be time-varying, linear or non-linear. The control parameters can also be updated by monitoring by a sensor.

Depending on different application scenarios, the adjusting the sound field of the dipole speaker unit 2 in the preset region here can be overall enhancement or weakening of the sound field in the preset region, or the enhancement or weakening of sub-frequency bands of the sound field in the preset region, to can also be custom-made adjustments to the amplitude, phase, signal delay, etc., which are not limited herein.

The above-mentioned preset region may be user-defined, or manufacturer-defined. Alternatively, the space is divided into a user region and a preset region through device-adaptive perception, which is not limited here.

The embodiments of the present disclosure provide the speaker assembly, where the speaker assembly forms the dipole sound source through the dipole speaker units to realize directional sound emission. In addition, the control unit can adjust the at least one control parameter for each of the dipole speaker units, thereby further adjusting the sound field of the dipole speaker unit in the preset region, thereby further improving effect of the directional sound emission and greatly improving the user experience.

The following describes the structure of each of three types of dipole speaker units.

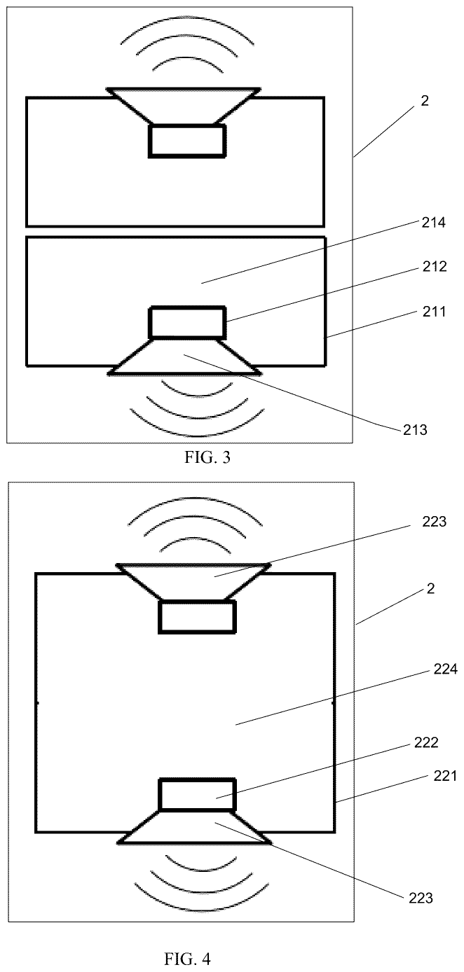

The structure of the first type of dipole speaker unit is shown in FIG. 3. Referring to FIG. 3, the dipole speaker unit 2 includes two first speakers separately provided, and driving signals for the two first speakers have inverted/opposite phases and a same amplitude.

Each first speaker includes a first housing 211 and a first sounding part 212. The first housing 211 has a first receiving cavity. The first sounding part 212 is provided inside the first housing 211 and divides the first receiving cavity into a first front sound cavity 213 and a first rear sound cavity 214. The first housing 211 defines at least one first sound-emitting hole. The first front sound cavity 213 communicates with outside of the first housing 211 through the at least one first sound-emitting hole. The first rear sound cavity 214 is enclosed. The first rear sound cavities 214 of the two first speakers face each other.

Each of the at least one first sound-emitting hole may be provided to have an arc shape, a circle shape, an ellipse shape, a triangle shape, a quadrilateral shape, a hexagonal shape, or the like. The at least one first sound-emitting hole may be embodied as a plurality of first sound-emitting holes, and the arrangement of the plurality of first sound-emitting holes is not limited. The first speaker is driven by electrostatic driving, piezoelectric driving, or electromagnetic driving.

The two first speakers described above have substantially identical structures. In this structure, the two first speakers are completely independently arranged, and the first rear sound cavities of the two first speakers are enclosed, so that the mutual interference between the two first speakers is small, which may be beneficial to modeling and debugging, and thus reduce design difficulty.

The structure of the second type of dipole speaker unit is shown in FIG. 4. Referring to FIG. 4, the dipole speaker unit 2 includes two second speakers that are communicatively coupled to each other, and driving signals for the two second speakers are inverted in phase and have a same amplitude.

The two second speakers that are coupled to each other include a second housing 221 and two second sounding parts 222. The second housing 221 defines a second receiving cavity. The two second sounding parts 222 are arranged opposite to each other in the second housing 221, and divides the second receiving cavity into a second rear sound cavity 224 and two second front sound cavities 223. The second housing 221 defines a plurality of second sound-emitting holes. Each of the two second front sound cavities 223 is communicated with outside of the second housing 221 through a corresponding second sound-emitting hole of the plurality of second sound-emitting holes. The second rear sound cavity 224 is enclosed.

Each of the plurality of second sound-emitting holes may be provided to have an arc shape, a circle shape, an ellipse shape, a triangle shape, a quadrilateral shape, a hexagonal shape, or the like. The plurality of second sound-emitting holes may be embodied as at least two second sound-emitting holes, and the arrangement of the at least two second sound-emitting holes is not limited. The second speaker is driven by electrostatic driving, piezoelectric driving, or electromagnetic driving.

In this structure, the two second speakers share the same second rear sound cavity, so that the volume of the rear sound cavity is larger, and the size of the rear sound cavity can be larger. Both the first type of dipole speaker unit and the second type of dipole speaker unit belong to the closed-cavity speaker structure.

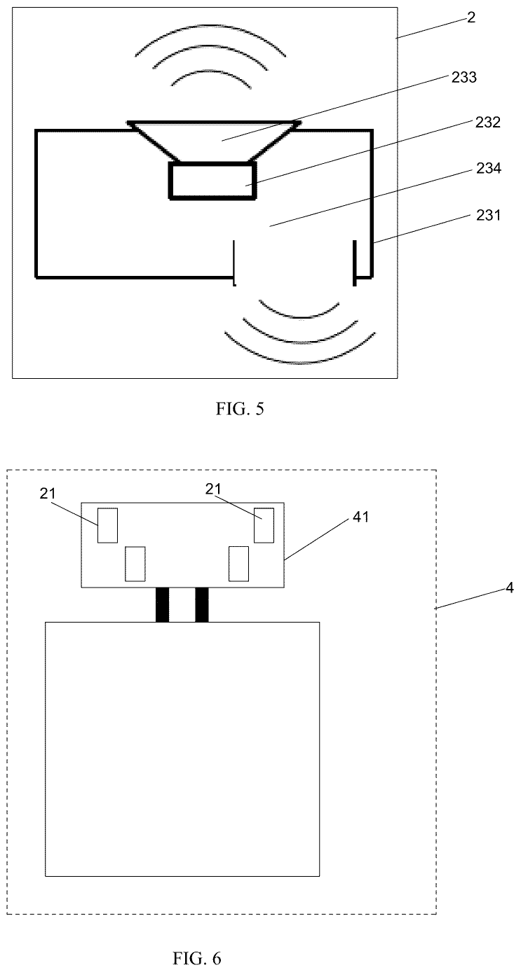

In the structure of the third type of dipole speaker unit, referring to FIG. 5, the dipole speaker unit includes a third speaker. The third speaker includes a third housing 231 and a third sounding part 232. The third housing 231 defines a third receiving cavity. The third sounding part 232 is provided in the third housing 231 and divides the third receiving cavity into a third front sound cavity 233 and a third rear sound cavity 234. The third housing 231 has at least one third sound-emitting hole and at least one fourth sound-emitting hole. The third front sound cavity 233 communicates with outside of the third housing 231 through the at least one third sound-emitting hole, and the third rear sound cavity 234 communicates with the outside of the third housing 231 through the at least one fourth sound-emitting hole.

Each of the at least one third sound-emitting hole and the at least one fourth sound-emitting hole may be provided to have an arc shape, a circle shape, an ellipse shape, a triangle shape, a quadrilateral shape, a hexagon shape, or the like. The at least one third sound-emitting hole is embodied as a plurality of third sound-emitting holes and the at least one fourth sound-emitting hole is embodied as a plurality of fourth sound-emitting holes, and arrangement of the plurality of third sound-emitting holes and arrangement of the plurality of fourth sound-emitting holes are not limited. The third speaker is driven by electrostatic driving, piezoelectric driving, or electromagnetic driving.

The third type of dipole speaker unit belongs to the opened-rear-cavity speaker structure. In this structure, the third rear sound cavity is not enclosed, and the acoustic waves emitted from the third rear sound cavity and the acoustic waves emitted from the third front sound cavity meet and superimpose, thereby forming a dipole acoustic source.

In one or more embodiments, each of the plurality of dipole speaker units includes any one of the dipole speaker unit including two separately disposed first speakers, the dipole speaker unit including two coupled second speakers, and the dipole speaker unit including one third speaker. That is, the plurality of dipole speaker units of the speaker assembly have a substantially same type of structure.

Alternatively, some of the plurality of dipole speaker units each include two separately disposed first speakers or two coupled second speakers, and the remaining dipole speaker units of the plurality dipole speaker units each include a third speaker. That is, the plurality of dipole speaker units of the speaker assembly are combinations of different types of structures.

In one or more embodiments, the speaker assembly is applied in a seat, and the mounting body is a headrest or a neck pillow, and the neck pillow may be detachable/clip-on neck pillow or integrated on the headrest of the seat, which is not limited herein. The material of the detachable neck pillow is softer and closer to the user's ear, which can improve the near-field loudness to a certain extent. In addition, the position of the detachable neck pillow can also be adjusted more conveniently according to different people's heights, so that the dipole speaker units fit the human ear better.

Here, there is no restriction on the specific shapes of the headrest and the neck pillow, and the following describes two structures as an example.

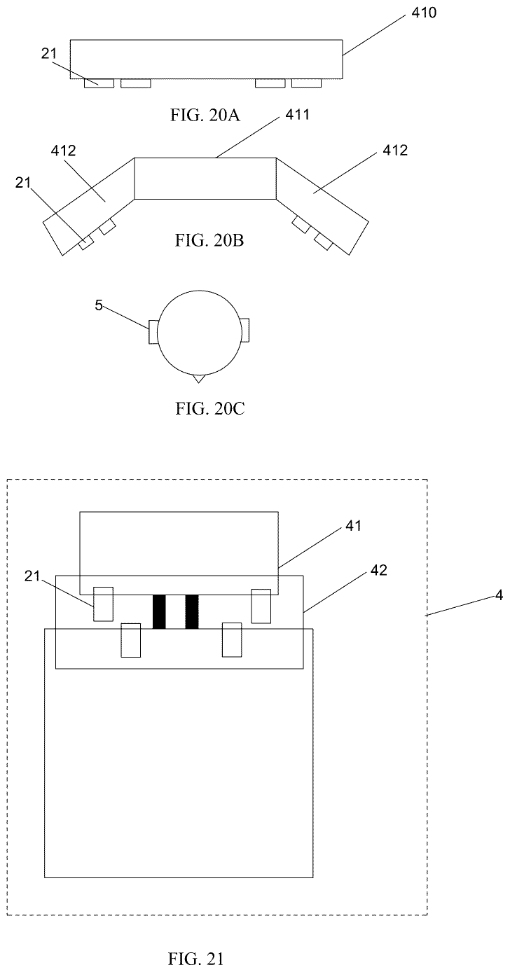

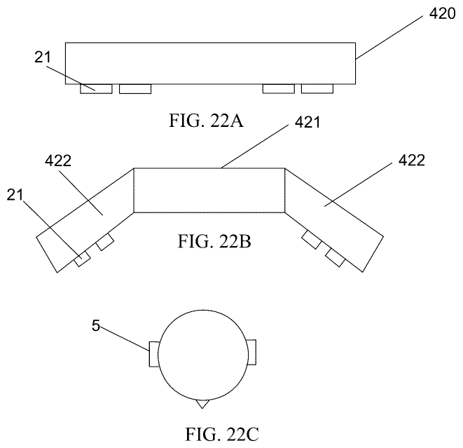

The first type of headrest or neck pillow is shown in FIG. 20A and FIG. 22A. With reference to FIG. 20A and FIG. 22A, the headrest or neck pillow includes a straight strip-shaped body portion (the straight strip-shaped body portion of the headrest in FIG. 20A is referred to as 410 and the straight strip-shaped body portion of the neck pillow in FIG. 22A is referred to as 420). The straight strip-shaped body portion has two opposite ends, and a respective dipole speaker unit is disposed inside each of the two opposite ends of the straight strip-shaped body portion (in FIGS. 20A and 22A, two dipole speaker units are illustrated, and each of the two dipole speaker units includes two first speakers 21).

The second type of headrest or neck pillow is shown in FIGS. 20B and 22B. Referring to FIGS. 20B and 22B, the headrest or neck pillow includes a curved body portion, and the curved body portion includes a straight strip-shaped subpart and two curved subparts (in FIG. 20B, the straight strip-shaped subpart of the headrest is referred to as 411, and each of the curved subparts is referred to as 412; in FIG. 22B, the straight strip-shaped subpart of the neck pillow is referred to as 421, and each of the curved subparts is referred to as 422). The two curved subparts are respectively located at both ends of the straight strip-shaped subpart. A respective dipole speaker unit is disposed inside each of the two curved subparts (in both FIGS. 20B and 22B, two dipole speaker units are used, and each of the two dipole speaker units includes two first speakers 21). In combination with FIGS. 20B and 20C and with FIGS. 22B and 22C, the curved headrest or neck pillow can partially surround the user's head 5, so that the dipole speaker units on both sides of the headrest or neck pillow are positioned more forward, which has a certain improvement effect on near-field loudness. Meanwhile, the curved headrest or neck pillow creates a stronger sense of sound-field enclosure. However, when designing, issues such as line-of-sight obstruction and impact safety need to be considered. Therefore, the lengths of the two curved subparts should not be too long.

In one or more embodiments, the at least one control parameter includes at least one of an amplitude of the driving signal, the phase of the driving signal, the delay time of the driving signal, and the frequency of the driving signal. By controlling these parameters, the control unit can adjust at least one of an amplitude, a phase, a delay time, and a frequency of the sound signal emitted by each dipole speaker unit, so as to adjust the sound field in the preset region.

Embodiments of the present disclosure further provide a seat. The seat includes the speaker assembly described above. The mounting body of the speaker assembly is a headrest or a neck pillow of the seat.

It shall be noted that the above-mentioned mounting body may also be other parts of the seat, such as: a top position or two side positions of the seat, and the like, which can be set according to actual needs.

Several types of seats will be described in detail below.

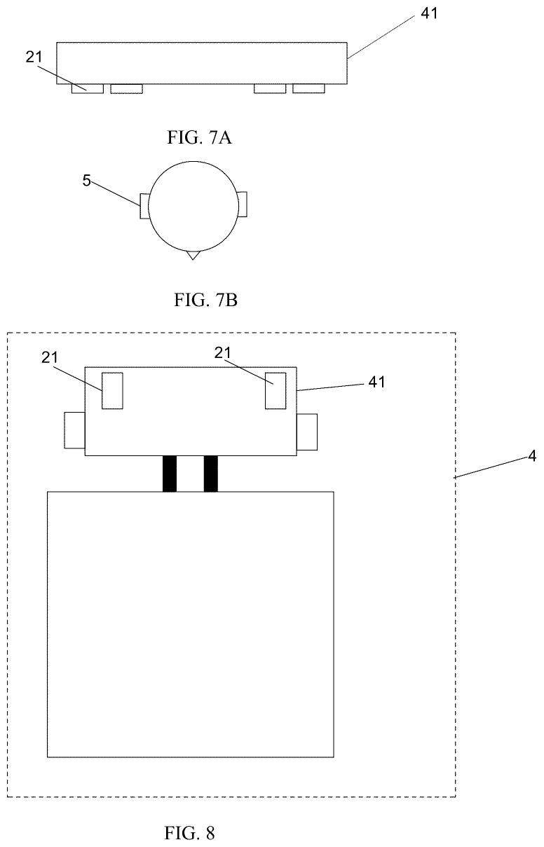

Referring to FIG. 6, the seat 4 includes a headrest 41. The headrest 41 is provided with two dipole speaker units arranged as shown in FIG. 6, and each dipole speaker unit of the two dipole speaker units includes two first speakers 21. Combined with FIG. 7A and FIG. 7B, the four first speakers have a same sound emitting surface and are positioned very close to the user's head 5, which has a certain improvement effect on near-field loudness.

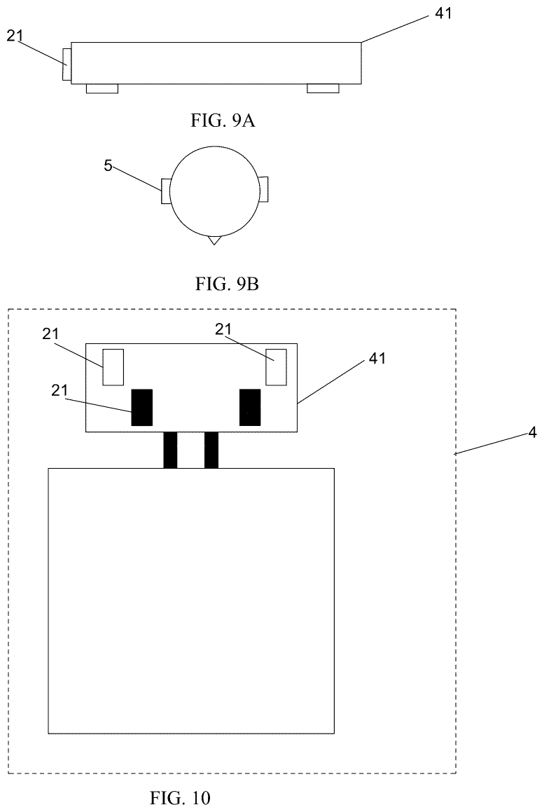

Referring to FIG. 8, the seat 4 includes a headrest 41. The headrest 41 is provided with two dipole speaker units arranged as shown in FIG. 8. Each dipole speaker unit of the two dipole speaker units includes two first speakers 21. The two first speakers 21 are disposed on different sides of the headrest. Combined with FIGS. 9A and 9B, the four first speakers 21 are positioned very close to the user's head 5, which has a certain improvement effect on near-field loudness.

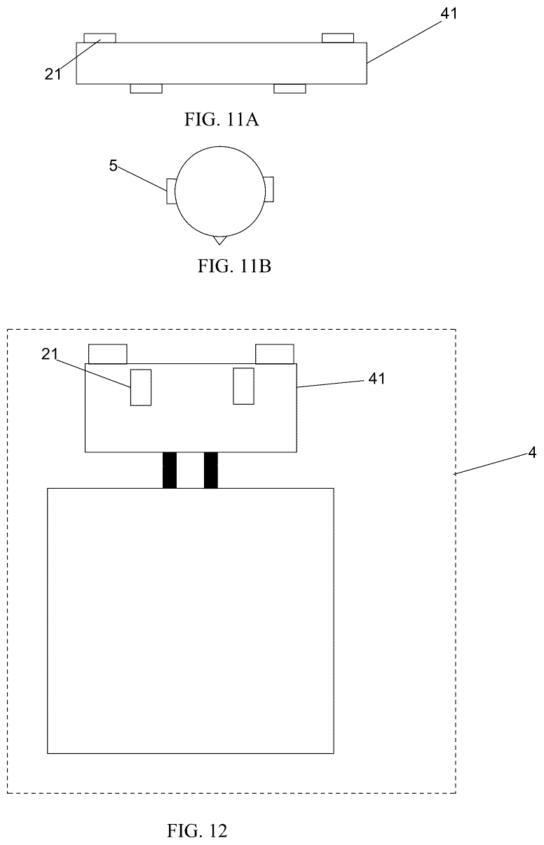

Referring to FIG. 10, the seat 4 includes a headrest 41. The headrest 41 is provided with two dipole speaker units arranged as shown in FIG. 10. Each dipole speaker unit of the two dipole speaker units includes two first speakers 21. The two first speakers 21 have opposite sound emitting surfaces (the sound emitting surfaces of the first speaker 21 located above (the first speaker 21 represented by the blank block) and the first speaker 21 located below (the first speaker 21 represented by the black block) in FIG. 10 are opposite). In combination with FIGS. 11A and 11B, the four first speakers 21 are positioned very close to the head 5 of the user, which has a certain improvement effect on near-field loudness.

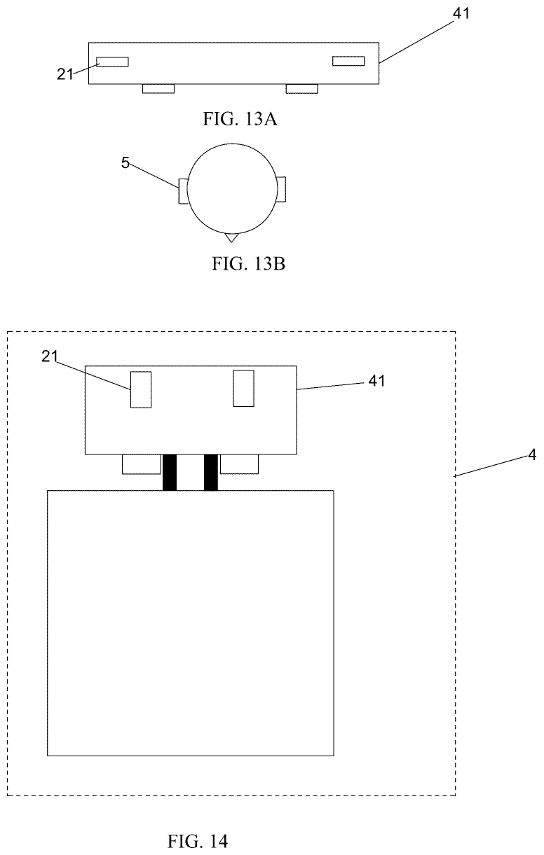

Referring to FIG. 12, the seat 4 includes a headrest 41. The headrest 41 is provided with two dipole speaker units arranged as shown in FIG. 12. Each dipole speaker unit of the two dipole speaker units includes two first speakers 21, and the two first speakers 21 are respectively arranged on different sides of the headrest 41. In combination with FIGS. 13A and 13B, the four first speakers 21 are positioned very close to the head 5 of the user, which has a certain improvement effect on near-field loudness.

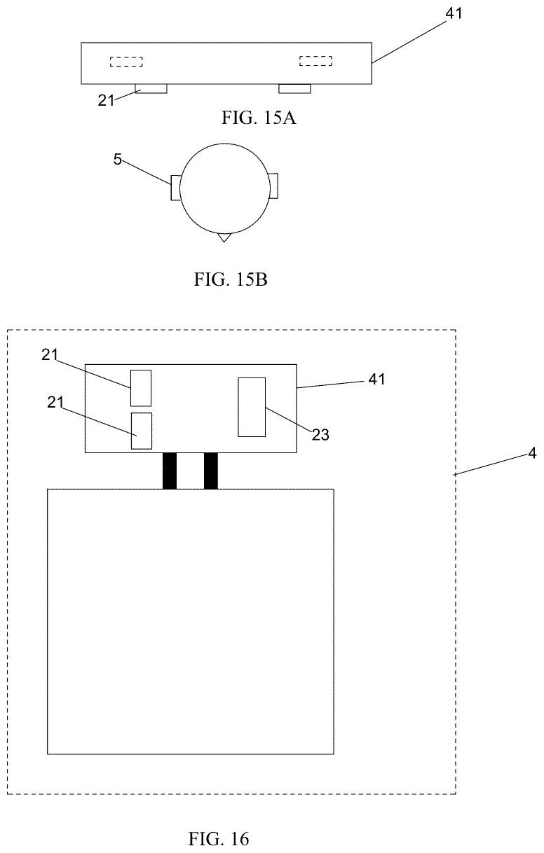

Referring to FIG. 14, the seat 4 includes a headrest 41. The headrest 41 is provided with two dipole speaker units arranged as shown in FIG. 14. Each dipole speaker unit of the two dipole speaker units includes two first speakers 21, and the two first speakers 21 are respectively arranged on different sides of the headrest 41. Combined with FIGS. 15A and 15B, the four first speakers 21 are positioned very close to the head 5 of the user, which has a certain improvement effect on near-field loudness.

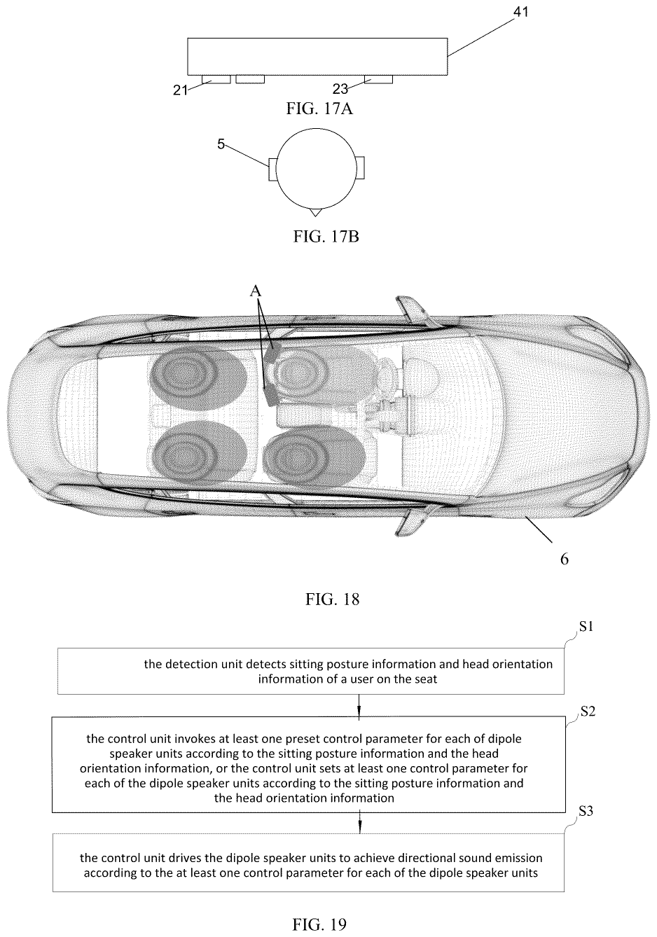

Referring to FIG. 16, the seat 4 includes a headrest 41. The headrest 41 is provided with two dipole speaker units arranged as shown in FIG. 16. In FIG. 16, the dipole speaker unit on the left includes two first speakers 21, and the dipole speaker unit on the right includes a third speaker 23. In connection with FIGS. 17A and 17B, the two first speakers 21 and the third speaker 23 are positioned very close to the user's head 5, which has a certain improvement effect on near-field loudness.

There is no restriction on application scenarios of the above-described seat. By way of example, the seat may be applied to an on-board scenario of a fuel vehicle or an electric vehicle, or may be applied to a non-on-board scenario such as an aircraft, a train, a cinema, and a game device.

The seat is equipped with the speaker assembly, and thus can achieve directional sound emission, which may greatly improve the user experience.

The embodiments of the present disclosure further provide an electronic device including the above-described seat. The electronic device may be any device or apparatus in which a seat is provided, such as a fuel vehicle, an electric vehicle, an airplane, a train, a cinema, or a game device. The electronic device has a directional sound emission function, which can greatly enhance the user experience.

Specifically, the following describes a vehicle as an example of the electronic device. Referring to FIG. 18, the driver's seat in the four-seat vehicle 6 integrates the above-described speaker assembly (the component labeled A in FIG. 18 represents a dipole speaker unit). A plurality of dipole speaker units may be provided in the headrest 41 as shown in FIG. 14 or the detachable neck pillow 42 as shown in FIG. 21 (in both FIGS. 14 and 21, two dipole speaker units are illustrated, where each dipole speaker unit includes two first speakers 21), thereby realizing directional sound emission at the driver's seat. In addition, the seats at other positions of the vehicle can also integrate the above-described speaker assembly, so that different audio contents can be played in different regions at different positions concurrently.

Embodiments of the present disclosure further provide a method for control of an electronic device. The electronic device includes the seat described above and a detection unit. The detection unit is electrically connected to a control unit of a speaker assembly provided in the seat.

Referring to FIG. 19, the method for control of the electronic device begins at S1.

At S1, the detection unit detects sitting posture information and head orientation information of a user on the seat.

At S2, the control unit invokes/accesses at least one preset control parameter for each of dipole speaker units according to the sitting posture information and the head orientation information, or the control unit sets at least one control parameter for each of the dipole speaker units according to the sitting posture information and the head orientation information.

At S3, the control unit drives the dipole speaker units to achieve directional sound emission according to the at least one control parameter for each of the dipole speaker units.

The control method can further improve the directional sound emission effect and improve the user experience.

It shall be understood by those skilled in the art that the above-described embodiments are specific embodiments for carrying out the present disclosure, and that various changes in form and detail may be made thereto in practical application without departing from the spirit and scope of the present disclosure. Any person skilled in the art can make various changes and modifications without departing from the spirit and scope of the present disclosure, and therefore, the scope of protection of the present disclosure should be based on the scope defined by the claims.

What is claimed is:

1. A speaker assembly, comprising:
a mounting body;
a plurality of dipole speaker units, wherein the plurality of dipole speaker units are disposed inside the mounting body and configured to form a dipole sound source to achieve directional sound emission; and
a control unit electrically connected with each dipole speaker unit of the plurality of dipole speaker units and configured to control at least one control parameter for the dipole speaker unit to adjust a sound field of the dipole speaker unit in a preset region.

2. The speaker assembly of claim 1, wherein the dipole speaker unit includes two first speakers disposed separately, and driving signals for the two first speakers have opposite phases and a same amplitude;
wherein each of the two first speakers includes a first housing and a first sounding part, wherein the first housing has a first receiving cavity, the first sounding part is provided inside the first housing and divides the first receiving cavity into a first front sound cavity and a first rear sound cavity, wherein the first housing defines at least one first sound-emitting hole, and the first front sound cavity communicates with outside of the first housing through the at least one first sound-emitting hole, wherein the first rear sound cavity is enclosed, and first rear sound cavities of the two first speakers face each other.

3. The speaker assembly of claim 1, wherein the dipole speaker unit includes two second speakers that are communicatively coupled to each other, and driving signals for the two second speakers have opposite phases and a same amplitude;
wherein the two second speakers communicatively coupled to each other include a second housing and two second sounding parts, and the second housing defines a second receiving cavity, wherein the two second sounding parts are disposed opposite to each other in the second housing, and divides the second receiving cavity into a second rear sound cavity and two second front sound cavities, wherein the second housing defines a plurality of second sound-emitting holes, each of the two second front sound cavities is communicated with outside of the second housing through a corresponding second sound-emitting hole of the plurality of second sound-emitting holes, and the second rear sound cavity is enclosed.

4. The speaker assembly of claim 1, wherein the dipole speaker unit includes a third speaker;
wherein the third speaker includes a third housing and a third sounding part, wherein the third housing defines a third receiving cavity, and the third sounding part is provided in the third housing and divides the third receiving cavity into a third front sound cavity and a third rear sound cavity, wherein the third housing has at least one third sound-emitting hole and at least one fourth sound-emitting hole, the third front sound cavity communicates with outside of the third housing through the at least one third sound-emitting hole, and the third rear sound cavity communicates with the outside of the third housing through the at least one fourth sound-emitting hole.

5. The speaker assembly of claim 1, wherein each of the plurality of dipole speaker units includes any one of the dipole speaker unit including two first speakers separately disposed, the dipole speaker unit including two second speakers coupled to each other, and the dipole speaker unit including one third speaker.

6. The speaker assembly of claim 1, wherein some of the plurality of dipole speaker units each include the two first speakers separately disposed or the two second speakers coupled to each other, and remaining dipole speaker units of the plurality dipole speaker units each include one third speaker.

7. The speaker assembly of claim 1, wherein the mounting body is a headrest or a neck pillow.

8. The speaker assembly of claim 7, wherein the headrest or the neck pillow includes a straight strip-shaped body portion, the straight strip-shaped body portion has two opposite ends, and a respective dipole speaker unit of the plurality of dipole speaker units is disposed inside a corresponding end of the two opposite ends of the straight strip-shaped body portion.

9. The speaker assembly of claim 7, wherein the headrest or the neck pillow includes a curved body portion, and the curved body portion includes a straight strip-shaped subpart and two curved subparts, wherein each of the two curved subparts is located at a corresponding end of both ends of the straight strip-shaped subpart, and a respective dipole speaker unit of the plurality of dipole speaker units is provided inside a corresponding curved subpart of the two curved subparts.

10. The speaker assembly of claim 1, wherein the at least one control parameter includes at least one of an amplitude of a driving signal, a phase of the driving signal, a delay time of the driving signal, and a frequency of the driving signal.

11. A seat, comprising a speaker assembly, wherein the speaker assembly comprises:
a mounting body;
a plurality of dipole speaker units, wherein the plurality of dipole speaker units are disposed inside the mounting body and configured to form a dipole sound source to achieve directional sound emission; and
a control unit electrically connected with each dipole speaker unit of the plurality of dipole speaker units and configured to control at least one control parameter for the dipole speaker unit to adjust a sound field of the dipole speaker unit in a preset region;
wherein the mounting body of the speaker assembly is a headrest or a neck pillow of the seat.

12. An electronic device, comprising a seat comprising a speaker assembly, wherein the speaker assembly comprises:
a mounting body;
a plurality of dipole speaker units, wherein the plurality of dipole speaker units are disposed inside the mounting body and configured to form a dipole sound source to achieve directional sound emission; and
a control unit electrically connected with each dipole speaker unit of the plurality of dipole speaker units and configured to control at least one control parameter for the dipole speaker unit to adjust a sound field of the dipole speaker unit in a preset region;
wherein the mounting body of the speaker assembly is a headrest or a neck pillow of the seat.
